(19) United States
(12) Patent Application Publication
(10) Pub. No.: US 2014/0252165 A1
(43) Pub. Date: Sep. 11, 2014

(54) Crash Load Attenuator for Water Ditching and Floatation

(71) Applicant: BELL HELICOPTER TEXTRON INC., Fort Worth, TX (US)

(72) Inventors: Michael R. Smith, Colleyville, TX (US); Cheng-Ho Tho, Irving, TX (US)

(73) Assignee: BELL HELICOPTER TEXTRON INC., Fort Worth, TX (US)

(21) Appl. No.: 13/787,087

(22) Filed: Mar. 6, 2013

(51) Int. Cl. B64C 25/54

(52) U.S. Cl. CPC B64C 25/54
USPC 244/105

(57) ABSTRACT

A flotation device is described herein. The floatation device comprising an air bladder; a girt coupled to the air bladder; and a load attenuator coupled to the girt. The load attenuator is further coupled to an airframe of an aircraft. The float bag is used in water landings of the aircraft.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Aircraft may be forced to make an emergency landing in water. In some cases, the aircraft may be equipped with inflatable devices, for example, float bags. The float bags may be inflated prior to the aircraft landing in water. The structure of the aircraft may be designed to withstand the force of the landing on the float bags.

### SUMMARY

In some embodiments of the disclosure an aircraft may comprise an airframe; a load attenuator coupled to the airframe; and a float bag coupled to the load attenuator. The load attenuator may be selected based upon characteristics of the aircraft. The load attenuator may be selected based upon an expected sea state. The load attenuator may be a textile load attenuator. The load attenuator may be a mechanical load attenuator. The load attenuator may be a frangible load attenuator. The float bag may be temporary. The float bag may be permanent. The aircraft may be a helicopter.

In other embodiments of the disclosure a flotation device may comprise an air bladder; a girt coupled to the air bladder; and a load attenuator coupled to the girt. The flotation device may further comprise a second load attenuator coupled to the girt; a second girt; a third load attenuator coupled to the second girt; a fourth load attenuator coupled to the second girt; a third girt; and a fifth load attenuator coupled to the third girt. The load attenuator may be a textile load attenuator. The load attenuator may be a mechanical load attenuator. The load attenuator may be a frangible load attenuator. The air bladder may be temporary. The air bladder may be permanent.

In yet other embodiments of the disclosure a method may comprise selecting a sea state and an aircraft; sizing at least one float bag for the aircraft; and selecting a load attenuator to be positioned between the aircraft and the float bag. Selecting may comprise analyzing characteristics of an aircraft and expected sea states. Selecting may comprise determining a peak retention load of the float bag during a water landing of the aircraft. A weight of an airframe of the aircraft upon selecting the load attenuator may be less than a weight of an airframe of a similar aircraft without load attenuators.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 is a drawing of an aircraft with float bags.

FIG. 2 is a drawing of a float bag with load attenuators assembly.

FIG. 3 is a drawing of a frangible load attenuator.

FIG. 4 is a graph of forces experienced with and without load attenuators installed.

FIG. 5 is a flowchart of a method for selecting a float bag.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Aircraft may occasionally make emergency landings or be forced to ditch in bodies of water. Certain regulations may specify certain ditching certification requirements for emergency water landings to minimize the probability of immediate injury to or provide escape provisions of the occupants of an aircraft. In order to allow occupants of the aircraft a better chance to escape after a water landing, flotation devices (e.g. float bags) may be installed on the aircraft. As used herein, the term float bag refers to any flotation device used on an aircraft for water landings whether temporary (e.g. inflatable float bags) or permanent (e.g. pontoons or floods). The float bags may allow for the aircraft to remain sufficiently upright and in adequate trim to permit safe and orderly evacuation of all personal and passengers of the aircraft.

Float bags may be required for aircraft that operate over water. The float bags may be attached to the airframe using airframe fittings. The float bags may be inflated prior to the aircraft making a water landing. The airframe may be designed to support the load experienced by the float bags during a water landing. In order to reduce the load transmitted to the airframe, a load attenuator may be installed between the float bag and the airframe. The load attenuator may reduce the load transmitted to the airframe and may therefore allow a lighter weight airframe and/or float bag supports to be used. In addition, the load attenuators may allow the aircraft to sit lower in the water, thereby lowering the center of gravity and reducing the possibility of the aircraft tipping after a water landing.

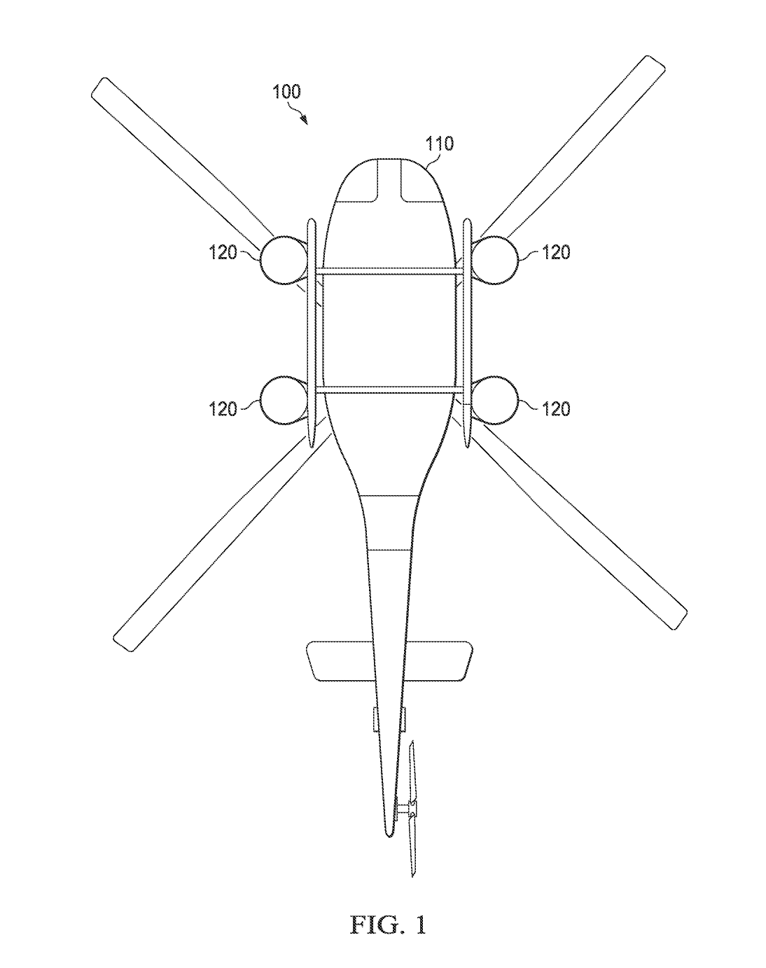

Referring now to FIG. 1, a drawing of an aircraft with float bags 100 is shown. The aircraft 110 may have several float bags 120 attached. While four float bags 120 are depicted, any number of float bags 120 may be used depending upon the characteristics of the aircraft 110 and/or the characteristics of the float bags 120. The float bags 120 may be attached to the aircraft's 110 airframe in a deflated state. In some embodiments, a pilot may deploy or inflate the float bags 120 when needed. In other embodiments, the float bags 120 may automatically deploy if a water landing is detected by sensors on the aircraft 110 and/or float bags 120. The airframe may be manufactured such that it withstands the load placed on it when the aircraft 110 makes a water landing with the float bags 120 inflated. In order to reduce the load placed on the airframe during a water landing, a load attenuator may be installed between the float bags 120 and the airframe of the aircraft 110. In aircraft without load attenuators 120, the float bag peak retention load under probable water conditions (i.e. sea state 4 or sea state 6) is significantly high such that the airframe fittings may need to be designed properly to carry such a high load. Typically aircraft without load attenuators may require a relatively heavy frame compared to the frame of an aircraft with load attenuators. Finally, although a helicopter is illustrated in FIG. 1, the load attenuators and float bags could be affixed to any type of aircraft, such as airplanes or tilt-rotor aircraft.

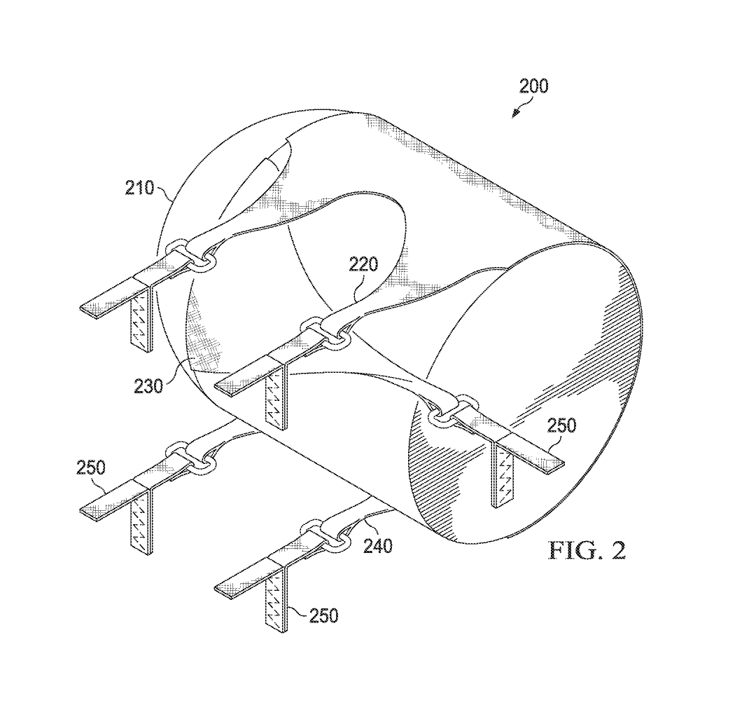

FIG. 2 is a drawing of a float bag with load attenuators assembly 200. The float bag with load attenuators assembly 200 contains an air bladder 210, an upper load girt 220, a lower load girt 240, a drag girt 230, and several load attenuators 250. The air bladder 210 may be any non-permeable material capable of containing air for floatation.

The upper load girt 220 may be attached to the air bladder 210. The upper load girt 220 may be made of the same material as the air bladder 210, or any other material suitable for attaching the upper load girt 220 to the air bladder 210. The upper load girt 220 may be made of a material that is flexible such that the air bladder 210 and upper load girt 220 may be stored in a deflated state within a storage container of some sort.

The lower load girt 240 may be attached to the air bladder 210. The lower load girt 240 may be made of the same material as the air bladder 210, or any other material suitable for attaching the lower load girt 240 to the air bladder 210. The lower load girt 240 may be made of a material that is flexible such that the air bladder 210 and lower load girt 240 may be stored in a deflated state within a storage container of some sort.

The drag girt 230 may be attached to the air bladder 210. The drag girt 230 may be made of the same material as the air bladder 210, or any other material suitable for attaching the drag girt 230 to the air bladder 210. The drag girt 230 may be made of a material that is flexible such that the air bladder 210 and drag girt 230 may be stored in a deflated state within a storage container of some sort.

As described above, the girts may be attached to the air bladder 210. In addition, some or all of the girts may be connected to a load attenuator 250. The load attenuators 250 are also attached to an airframe of an aircraft. By incorporating a load attenuator 250, the peak retention load of the float bags during a water ditching or water emergency landing may be greatly reduced relative to a similar situation where no load attenuator is installed. For example, the same energy absorption is maintained in the case where a load attenuator is installed, while the stroking distance (i.e. deflection) may be increased relative to the case where a load attenuator is not installed.

The load attenuators 250 may be textile load attenuators, frangible load attenuators, torsion bar load attenuators, or any other load attenuator/load limiter that may be available. As used herein, the term load attenuator refers to any device that decreases a shock load on at least one end of the device, typically by mechanized deformation of the device. Load attenuator may also refer to a load limiter. The load attenuators described herein may include a mechanical energy attenuation device and/or a textile energy attenuation device. As an example, a textile load attenuator may be a fold of fabric sewn with stitching, where the stitching is designed to break when a certain force is applied. Upon an impact with enough force, the stitches break causing the fabric to unfold. As the fabric unfolds, the load transmitted by the bodies on either side of the load attenuator is reduced. As another example, a torsion bar load attenuator uses a torsion bar (a length of metal) that twists when a certain force is applied to it. Upon an impact that produces a great enough force, the torsion bar twists and reduces the load transmitted by the bodies on either side of the load attenuator is reduced. The load attenuators may be activated with a crush initiator (with a pre-determined strength). The load attenuators may function in a progressive failure fashion which may result in limiting the peak load while maintaining or even increasing the energy absorption.

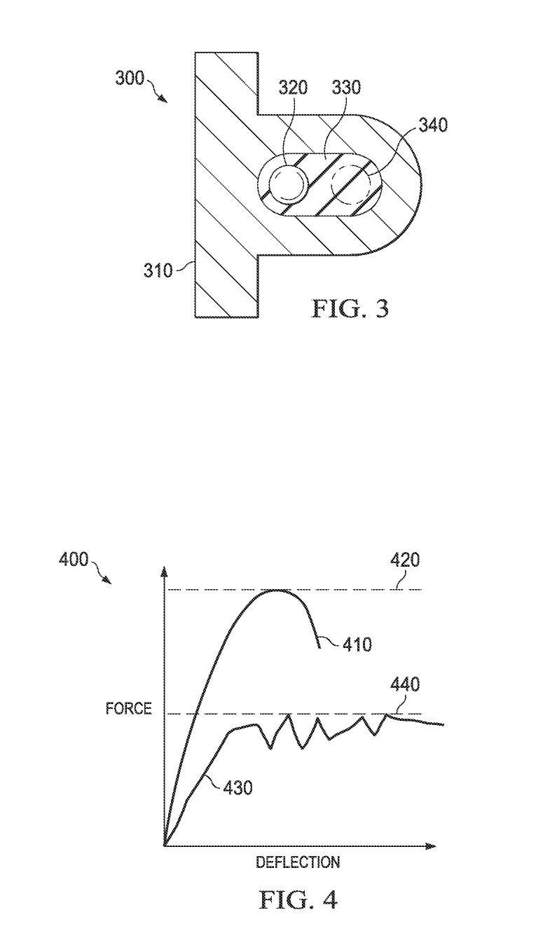

Another example of a load attenuator is provided in FIG. 3. FIG. 3 is a drawing of a frangible load attenuator 300. A frangible load attenuator may comprise a non-frangible casing 310 surrounding a frangible material 330. The frangible material may have a lower tensile strength than the non-frangible material. For example, the frangible material may be aluminum or plastic, while the non-frangible material may be steel. A non-frangible fastener 320 may be placed in the frangible material 330. The non-frangible fastener 320 may shear the frangible material 330 upon experiencing a great enough force. Upon experiencing an impact with enough force to shear the frangible material 330, the non-frangible fastener 320 may move to the position indicated at index 340.

The type and size of load attenuator selected for use in certain embodiments may depend on one or more of the following factors: characteristics of the aircraft, characteristics of the float bags, and probable water conditions upon landing. The water conditions may be based on various sea states defined by the world meteorological organization, the Douglas Sea Scale, or the Beaufort scale. Certain regulations may require that the aircraft be able to withstand a water landing in certain sea states, for example a sea state 4 or sea state 6. Installing a load attenuator between the float bags and the airframe may allow for a lighter weight airframe to be selected for use on the aircraft. Additionally, the load attenuator may allow the aircraft to sit lower in the water and consequently decrease the chance of the aircraft capsizing in higher sea states. Specifically, in the case of a helicopter, a large overhead mass of equipment may be present, for example, the transmission, rotor, and engines may all be located at the top of the aircraft, thus lowering the entire aircraft will decrease the center of gravity and increase flotation stability.

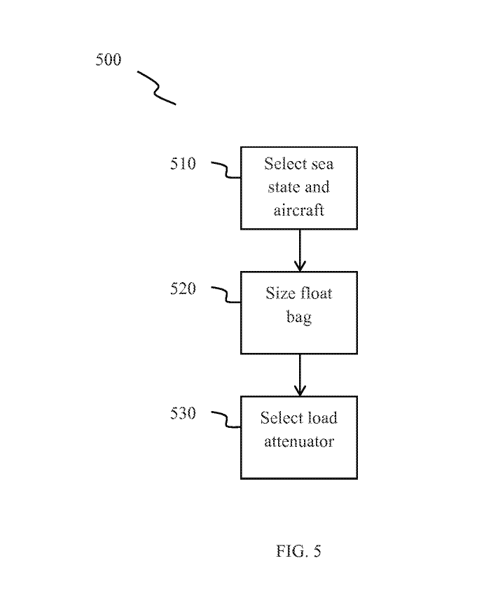

FIG. 4 is a graph of the forces experienced with and without load attenuators installed 400. Curve 410 is a representation of the forces encountered during a water landing on an aircraft with float bags installed without load attenuators. Curve 430 is a representation of the forces encountered during a water landing on an aircraft with float bags installed with load attenuators. The maximum force experienced without load attenuators 420 may be almost double the maximum force experienced with load attenuators 440.

FIG. 5 is a flowchart of a method for selecting a float bag. The method begins at step 510 by selecting a sea state and an aircraft. The method continues at step 520 by sizing at least one float bag suitable for the aircraft and sea state. The method ends at step 530 by selecting a load attenuator for positioning between the float bag and the aircraft.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Unless otherwise stated, the term “about” shall mean plus or minus 10 percent of the subsequent value. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

1. An aircraft comprising:
an airframe;
a load attenuator coupled to the airframe; and
a float bag coupled to the load attenuator.

2. The aircraft of claim 1, wherein the load attenuator is selected based upon characteristics of the aircraft.

3. The aircraft of claim 1, wherein the load attenuator is selected based upon an expected sea state.

4. The aircraft of claim 1, wherein the load attenuator is a textile load attenuator.

5. The aircraft of claim 1, wherein the load attenuator is a mechanical load attenuator.

6. The aircraft of claim 1, wherein the load attenuator is a frangible load attenuator.

7. The aircraft of claim 1, wherein the float bag is temporary.

8. The aircraft of claim 1, wherein the float bag is permanent.

9. The aircraft of claim 1, wherein the aircraft is a helicopter.

10. A flotation device comprising:
an air bladder;
a girt coupled to the air bladder; and
a load attenuator coupled to the girt.

11. The flotation device of claim 10 further comprising:
a second load attenuator coupled to the girt;
a second girt;
a third load attenuator coupled to the second girt;
a fourth load attenuator coupled to the second girt;
a third girt; and
a fifth load attenuator coupled to the third girt.

12. The flotation device of claim 10, wherein the load attenuator is a textile load attenuator.

13. The flotation device of claim 10, wherein the load attenuator is a mechanical load attenuator.

14. The flotation device of claim 10, wherein the load attenuator is a frangible load attenuator.

15. The flotation device of claim 10, wherein the air bladder is temporary.

16. The flotation device of claim 10, wherein the air bladder is permanent.

17. A method comprising:
selecting a sea state and an aircraft;
sizing at least one float bag for the aircraft; and
selecting a load attenuator to be positioned between the aircraft and the float bag.

18. The method of claim 17, wherein selecting comprises analyzing characteristics of an aircraft and expected sea states.

19. The method of claim 17, wherein selecting comprises determining a peak retention load of the float bag during a water landing of the aircraft.

20. The method of claim 17, wherein a weight of an airframe of the aircraft upon selecting the load attenuator is less than a weight of an airframe of a similar aircraft without load attenuators.
